(19) United States
(12) Patent Application Publication
(10) Pub. No.: US 2025/0284083 A1
(43) Pub. Date: Sep. 11, 2025

(54) TELECOMMUNICATIONS CABINET

(71) Applicant: CommScope Technologies LLC, Hickory, NC (US)

(72) Inventors: Arturo MAYA PEREYRA, Ciudad Juarez (MX); Robert BACHTELL; Jesus Gustavo PURECO CHICO, Ciudad Juarez (MX)

(73) Assignee: CommScope Technologies LLC, Hickory, NC (US)

(21) Appl. No.: 18/861,501

(22) PCT Filed: Apr. 28, 2023
(86) PCT No.: PCT/US2023/020433

§ 371 Date: Oct. 29, 2024

Related U.S. Application Data
(60) Provisional application No. 63/336,688, filed on Apr. 29, 2022.

(51) Int. Cl. G02B 6/44

(52) U.S. Cl. CPC G02B 6/44524

(57) ABSTRACT

A telecommunications cabinet includes a housing defining an interior. A front includes an open front portion, and an access door is provided for selectively accessing the interior of the cabinet through the open front portion. Equipment is positioned within in the cabinet. A cable management panel manages cables on a front of the cable management panel between the equipment. A rear space is provided behind the cable management panel for routing of additional cables, such as between the input and output cables and the equipment. An access panel is provided to access the rear space.

### CROSS-REFERENCE TO RELATED APPLICATIONS

This application is being filed on Apr. 28, 2023, as a PCT International application and claims the benefit of and priority to U.S. Patent Application No. 63/336,688, filed on Apr. 29, 2022, the disclosure of which is hereby incorporated by reference in its entirety.

### BACKGROUND

Telecommunications cabinets are known for routing optical fibers and making optical connections between equipment within the cabinet. The telecommunications cabinet receives incoming cables and outgoing cables to connect such entities as a central office to customers. Good cable management to avoid tangled arrangements of cables, as well as improved cable access for technicians are desired.

### SUMMARY

A telecommunications cabinet includes a housing defining an interior. The housing includes a front, a rear, a top, a bottom, a right side, and a left side. The front includes an open front portion. An access door is provided for selectively accessing the interior of the cabinet through the open front portion. Equipment is positioned in the cabinet at least on one side of the cabinet. In one embodiment, equipment is provided on both sides of the cabinet. A main cable management panel is provided to manage cables on a front of the cable management panel. A rear space is provided behind the main cable management panel for routing of additional cables, such as between the input and output cables and the equipment. The main cable management panel can manage cables between the equipment. An access panel is provided to gain access to the rear space behind the main cable management panel without removing the main cable management panel.

### BRIEF DESCRIPTION OF THE DRAWINGS

FIG. 1 is a perspective view of a telecommunications cabinet in accordance with one embodiment of the invention, showing an access door in an open position.

FIG. 2 is a further perspective view of the cabinet of FIG. 1, with the front access door removed.

FIG. 3 is a further perspective view of the cabinet of FIG. 2.

FIG. 4 is a front view of the cabinet of FIG. 2.

FIG. 5 shows an access panel removed from the cabinet for accessing a rear space within the cabinet.

FIG. 6 shows the cabinet of FIG. 2, with the cable management panel and the access panel both removed to access the rear space.

FIGS. 7 and 8 show a splitter module used in the cabinet of FIG. 1.

FIGS. 9 and 10 show a connection module used in the cabinet of FIG. 1.

FIGS. 11 and 12 show a connector storage module used in the cabinet of

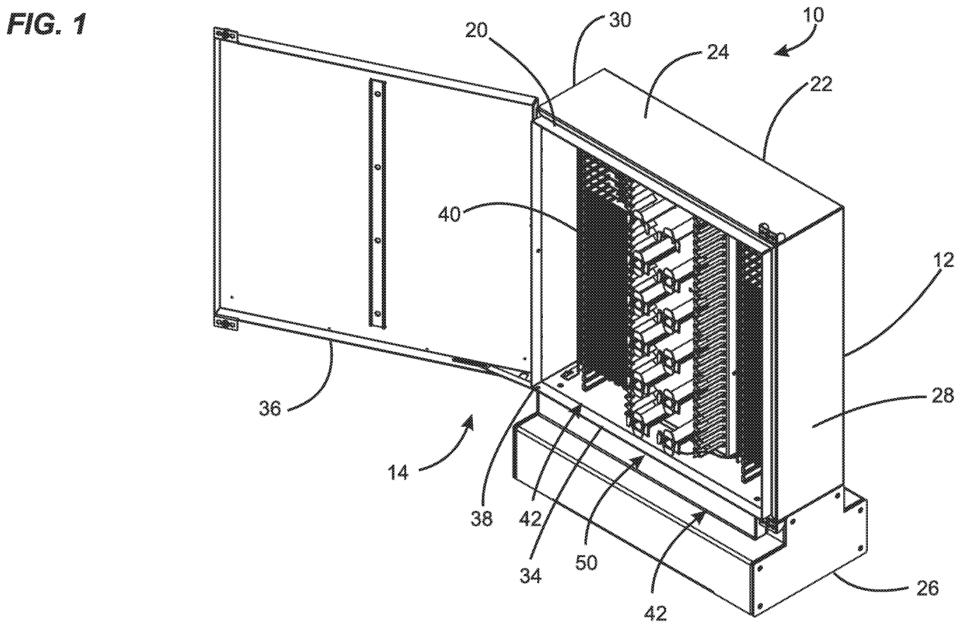

FIG. 1.

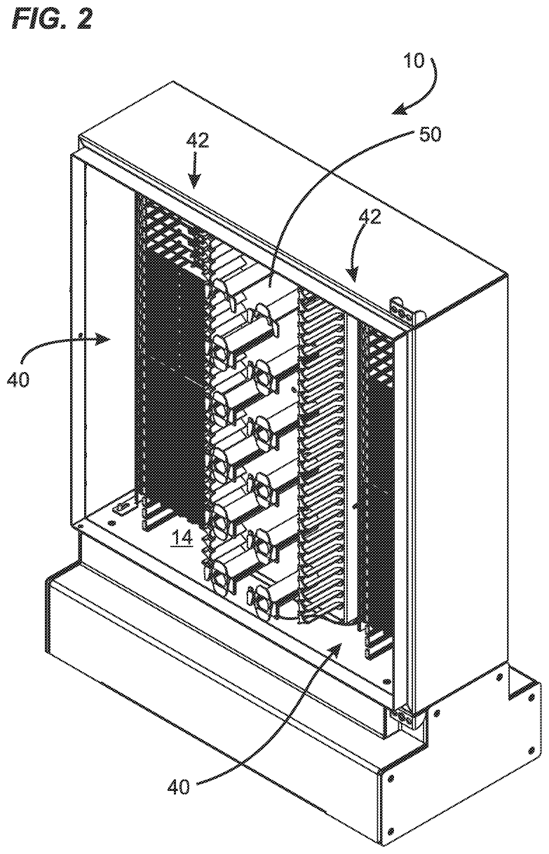

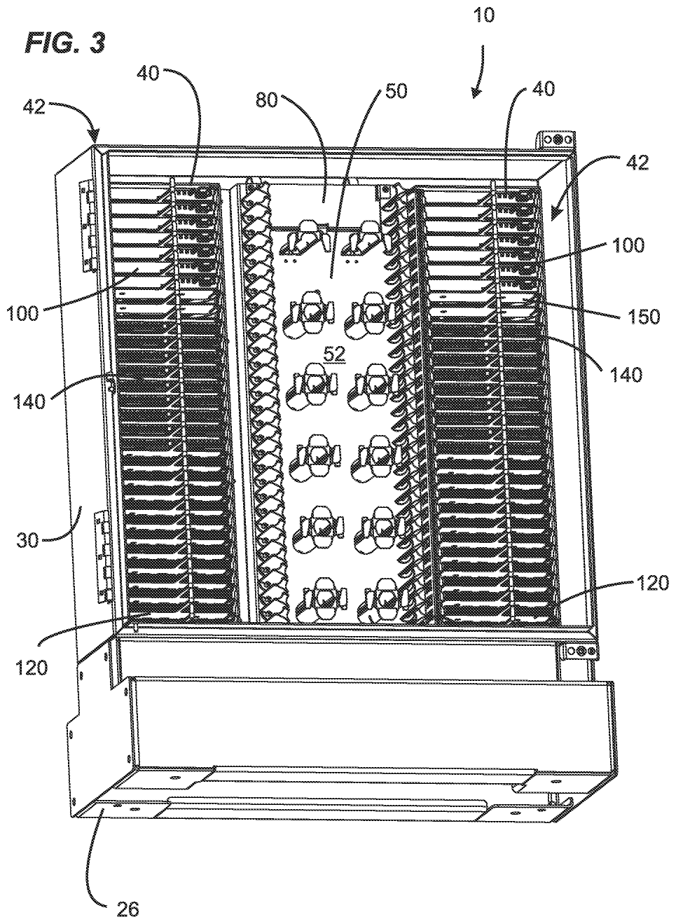

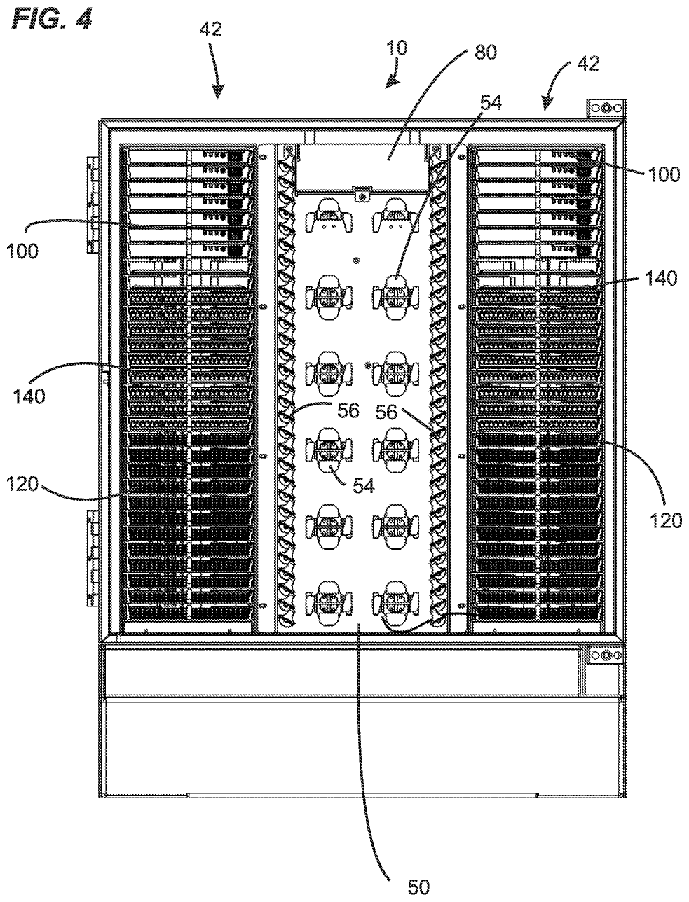

FIGS. 13 and 14 show an equipment tray of the cabinet of FIGS. 1-4.

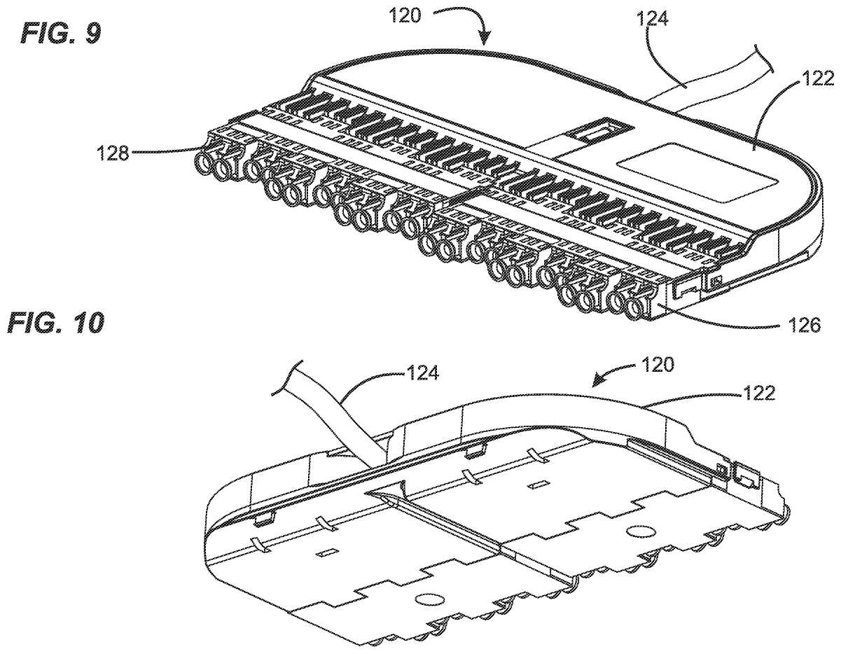

FIGS. 15 and 16 show the connection module of FIGS. 9 and 10 mounted to the equipment tray of FIGS. 13 and 14.

FIG. 17 shows the cabinet of FIGS. 1-4 with front cables connecting the various pieces of equipment to one another.

FIG. 18 shows a technician removing the access panel to gain access to the rear space behind the main cable management panel.

### DETAILED DESCRIPTION

Referring now to FIGS. 1-4, a telecommunications cabinet 10 includes a housing 12 defining an interior 14. The housing 12 includes a front 20, a rear 22, a top 24 a bottom 26, a right side 28 and a left side 30. The front 20 has an open front portion 34 which is closed off by an access door 36. In the example shown a hinge 38 hingedly attaching access door 36 to open front portion 34 for selective interior access to cabinet 10.

Equipment 40 is positioned in the interior 14. In one embodiment, equipment 40 is positioned on both sides of the interior of the cabinet 10. The equipment 40 is provided in two columns 42 separated by a spacing 44.

A main cable management panel 50 is provided in the spacing 44 between the two columns 42 of equipment 40. The main cable management panel 50 manages cables, such as patch cords, and/or splitter inputs and outputs on a front side 52 of main cable management panel 50. Front side 52 of main cable management panel 50 includes a plurality of cable spools or radius limiters 54 which can store slack and support and route the front cables within cabinet 10. Front side 52 of main cable management panel 50 also includes two columns of cable management fingers 56 which can support and route the front cables within cabinet 10.

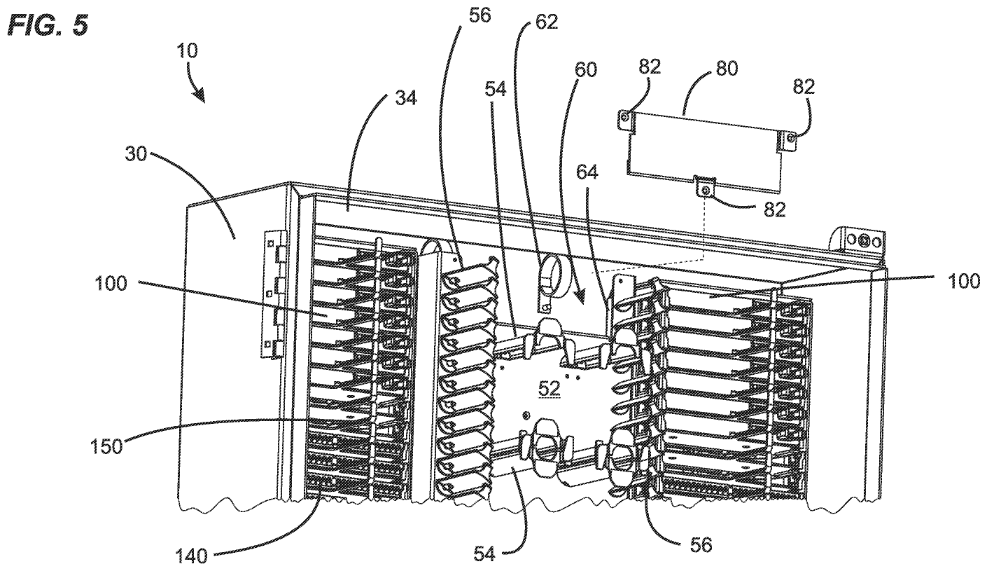

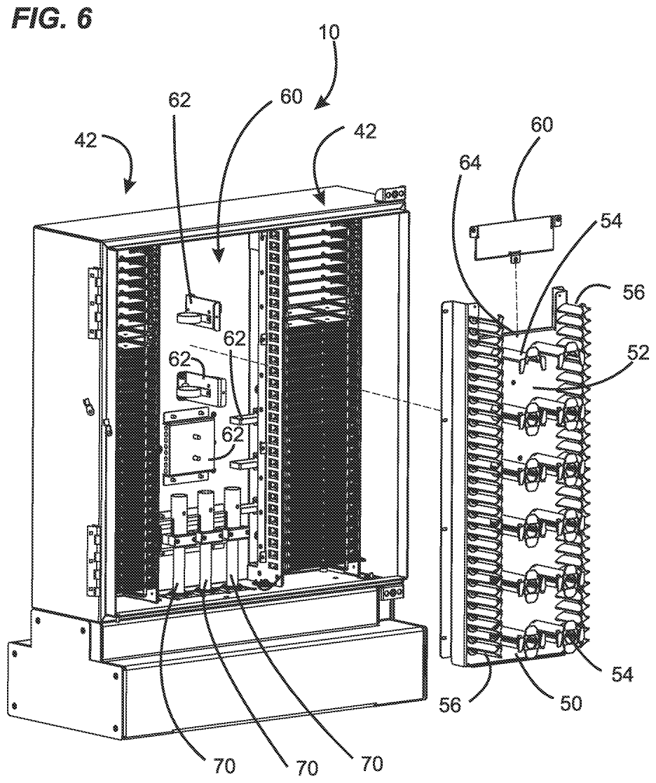

Now with reference to FIGS. 5 and 6, a rear space 60 is provided behind the main cable management panel 50 and behind equipment 40 for routing of additional cables, such as between the input and output cables 70 and the equipment 40. Breakouts can also be housed in rear space 60. Main cable management panel 50 is removably mounted to cabinet 10. However, once front cables are positioned on the front side 52 of main cable management panel 50, any movement or removal of main cable management panel 50 is difficult or impossible. Cabinet 10 is provided with an access panel 80 to allow a technician to access the rear space 60 for the purpose of manipulating any of the rear cabling once the front cabling is installed on main cable management panel 50. See also FIGS. 17 and 18.

Main cable management panel 50 is separable from of remainder of cabinet 10 as shown in FIG. 6, such as during initial cabinet, cable and equipment installation. As noted, once front cabling is added to main cable management panel 50, it is no longer desired that main cable management panel 50 be movable or removable with respect to cabinet 10.

Access panel 80 includes one or more flanges 82 for affixing access panel 80 to main cable management panel 50 with fasteners. Access panel 80 is located in an upper central portion of main cable management panel 50. Once access panel 80 is removed, a technician is allowed hand access to rear space 60 through opening 64 for accessing any cables and cable management devices 62 positioned in a rear space 60. In one example, if equipment 40 is to be removed from one of the columns 42 with respect to the remaining equipment 40, the technician may need to release the rear cabling from a cable management device 62 so that the selected equipment 40 can be moved forward from its column 42 in cabinet 10. The equipment 40 might need to be removed to clean any front adapters or front connectors, or to access an interior of the equipment, such as to conduct a repair of a splice or splitter component.

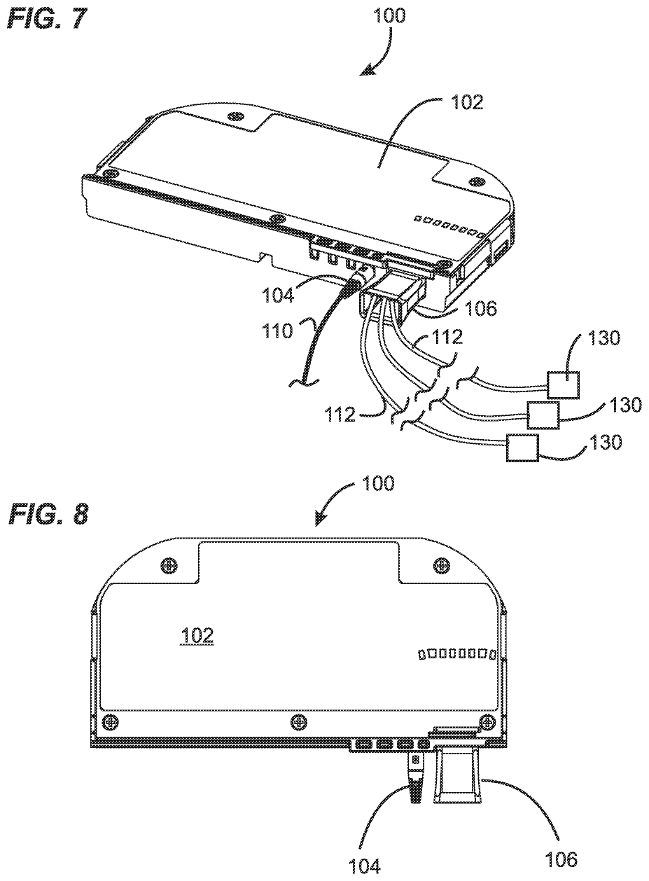

Referring now to FIGS. 7 and 8, a splitter module 100 is shown as one example of equipment 40. Splitter module 100 includes a housing 102, a cable input port 104 and a cable output port 106. Contained within splitter module 100 can be cable splices and a cable splitter to split the input from input cable 110 into multiple outputs on output cables 112. Similar splitter modules are shown in U.S. Pat. No. 10,495,833, the disclosure of which is hereby incorporated by reference.

Referring now to FIGS. 9 and 10, a connection module 120 is shown the connection module includes a housing 122 and input cable 124 and output adapters 126. Cable 124 may include a bundle of individual fibers which are fanned out to individual rear fiber optic connectors positioned on the rear ports (not visible) of adapters 126. Front ports 128 of adapters 126 are suitable for receiving a front fiber optic connector 130 terminating the end of a cable 132, wherein the front connector is in fiber signal communication with the rear connector. See FIGS. 15 and 17.

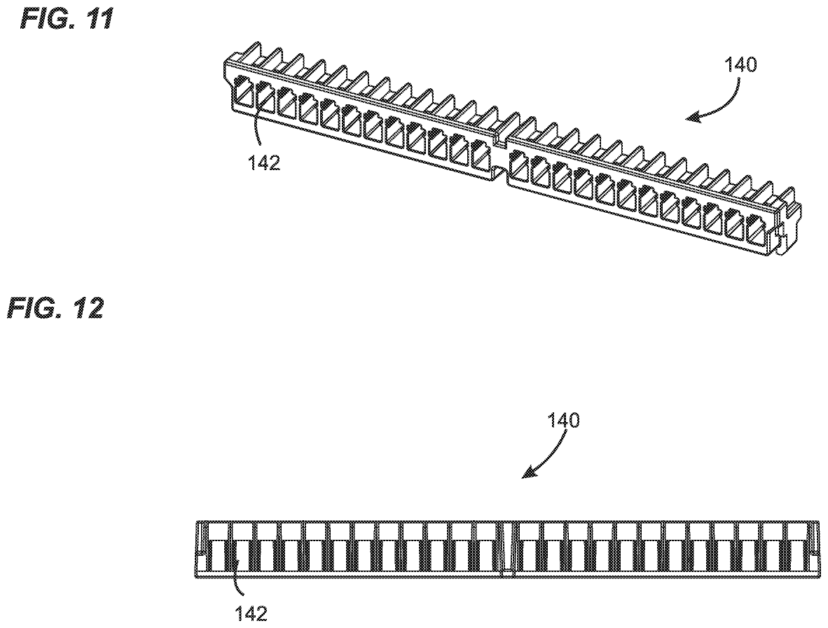

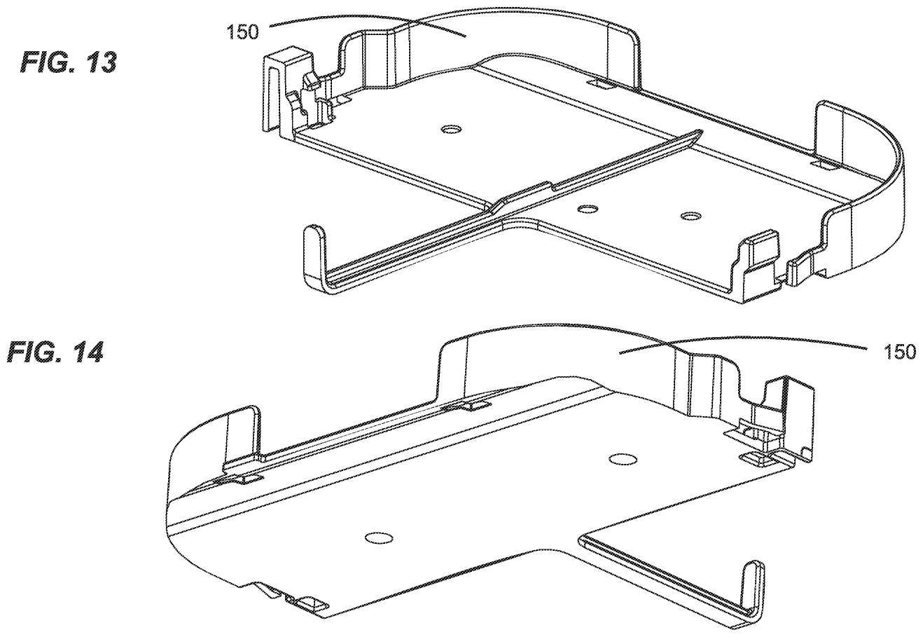

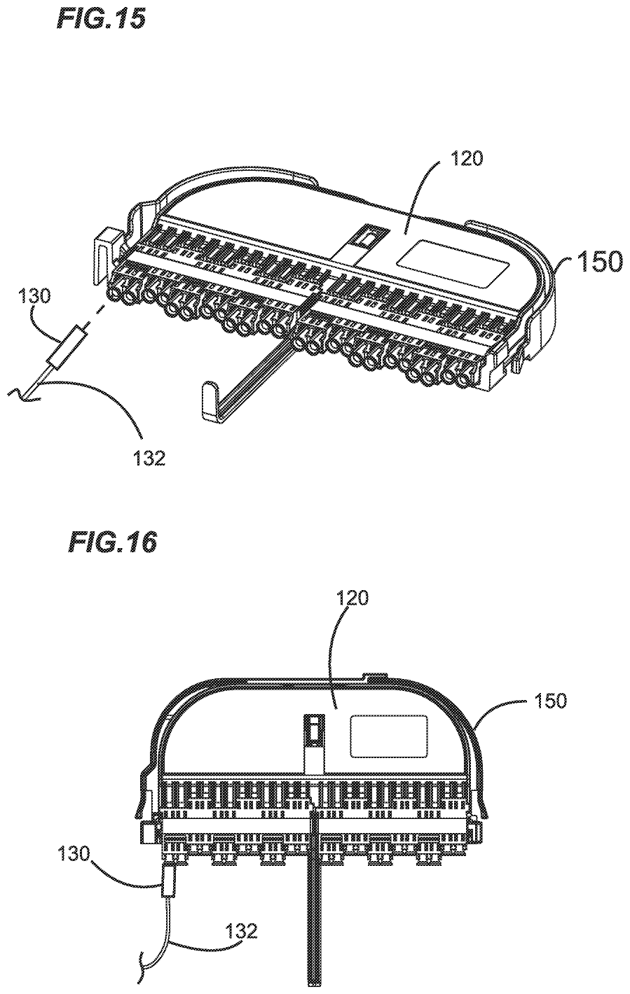

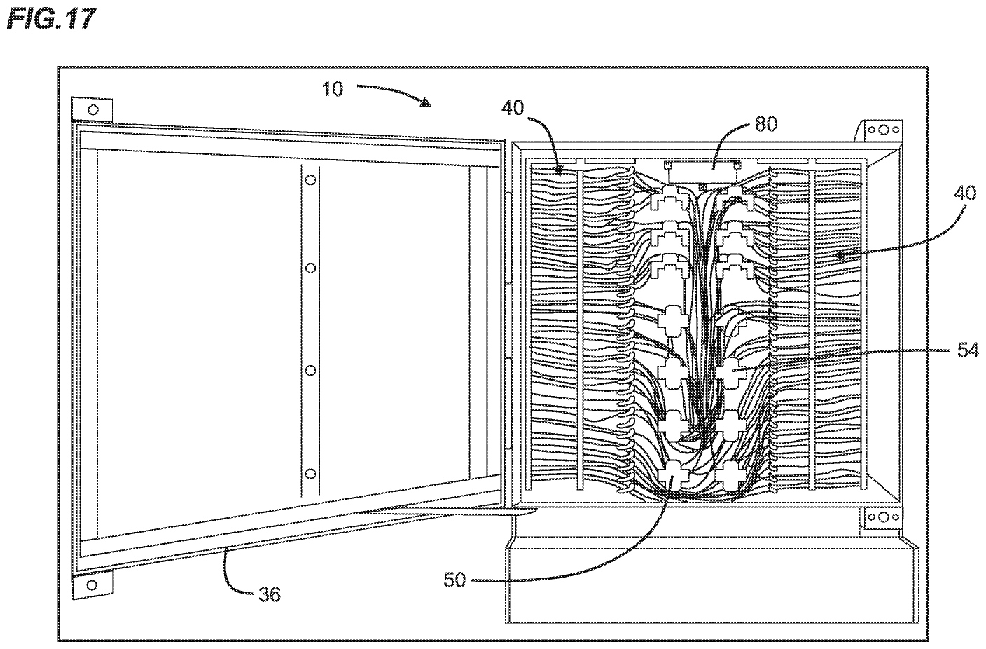

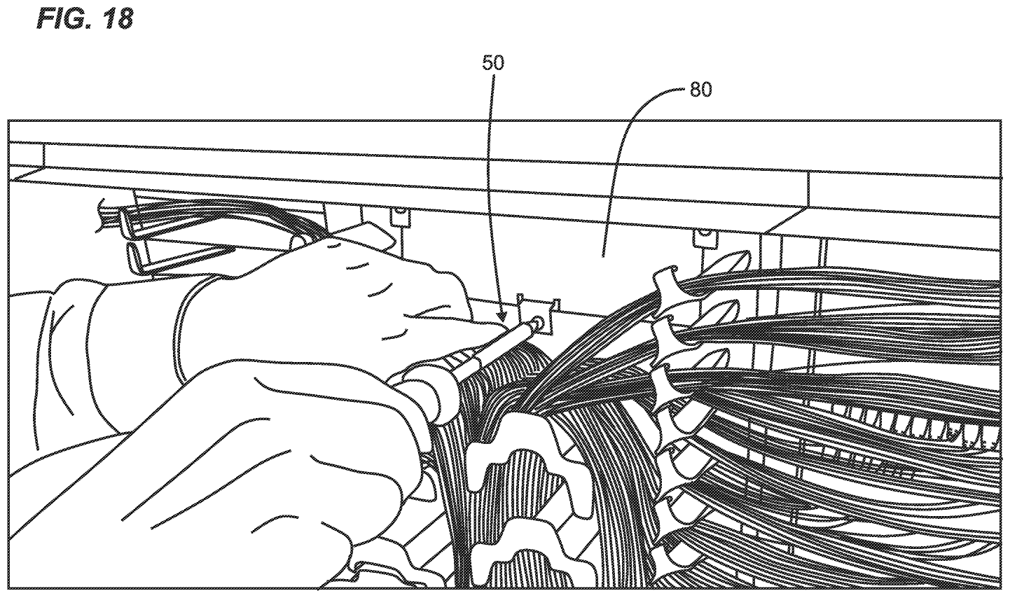

Referring now to FIGS. 11 and 12, a connector storage module 140 is shown for use in the cabinet of FIGS. 1-4. Connector storage module 140 houses the ends of front fiber optic connectors 130 of cables 112 that are not yet needed for connection to other equipment, so that the unused front fiber optic connectors are securely stored in an organized manner.

FIGS. 13 and 14 show an equipment tray 150 of the cabinet of FIGS. 1-4. A plurality of the equipment trays 150 are assembled within cabinet 10 in two columns for holding the equipment, such as the splitter modules 100, the connection modules 120, and the connector storage modules 140. In one example, the equipment 40 snaps to the respective equipment tray 150.

FIGS. 15 and 16 show the connection module 120 of FIGS. 9 and 10 mounted to the equipment tray 150 of FIGS. 13 and 14. Similar trays and connections modules are shown in U.S. Pat. Nos. 10,495,833; 10,802,238; and 10,809,465, the disclosures of which are hereby incorporated by reference.

When access to a desired equipment, such as connection module 120, is needed, connection module 120 is separated from the cabinet and/or its respective equipment tray 150. In some cases, just the equipment 40 is removed, or both the equipment and its tray can be removed. Should any rear cabling associated with cable 124 be restrained by a cable management device or possibly interfered with by other cables or devices, access panel 80 can be removed allowing a technician to reach through opening 64 to free up the necessary slack for cable 124 to all connection module 120 to be removed from an interior of cabinet 10.

FIG. 17 shows the cabinet 10 of FIGS. 1-4 with front cables connecting the various pieces of equipment to one another. These cables can be patch cords having connectors on opposite ends. These cables can also be splitter inputs or splitter outputs with or without connectorized ends. As can be seen by reviewing FIG. 17, due to the cable routing and the number of cables, it would be difficult or impossible to move or remove main cable management panel 50 to access the rear space 60 behind main cable management panel 50. FIG. 18 shows a technician beginning to remove the access panel 80 to gain hand access to the rear space 60 behind the main cable management panel 50 for releasing held cables so as to allow removal of one or more of the telecommunications equipment 40 held within cabinet 10.

1. A telecommunications cabinet comprising:
a housing defining an interior, the housing including a front, a rear, a top, a bottom, a right side, and a left side;
the front including an open front portion;
an access door for selectively accessing the interior of the cabinet through the open front portion;
equipment mounting locations positioned in the cabinet at least on one side of the cabinet;
a cable management panel with cable management devices on a front of the cable management panel;
wherein a rear space is provided behind the cable management panel for routing of additional cables, such as between the input and output cables and the equipment;
a movable front access panel for gaining access to the rear space behind the cable management panel without removing the cable management panel.

2. The telecommunications cabinet of claim 1, wherein the access panel is located at an upper portion of the cable management panel.

3. The telecommunications cabinet of claim 1, wherein the access panel is mounted to the cable management panel with a fastener.

4. The telecommunications cabinet of claim 1, wherein equipment mounting locations are provided on both sides of the cabinet, in the form of two columns, wherein the cable management panel is located between the two columns of equipment mounting locations.

5. The telecommunications cabinet of claim 1, wherein the front access panel is attachable to the cable management panel and removable from the cable management panel.

6. The telecommunications cabinet of claim 1, wherein the equipment mounting locations include a plurality of trays.

7. The telecommunications cabinet of claim 1, wherein the cable management devices include a plurality of radius limiting spools.

8. The telecommunications cabinet of claim 1, wherein the cable management devices include at least one column of radius limiting fingers.

9. The telecommunications cabinet of claim 1, wherein the cabinet includes telecommunications equipment mounted to the equipment mounting locations.

10. The telecommunications cabinet of claim 9, wherein the telecommunications equipment includes one or more splitter modules.

11. The telecommunications cabinet of claim 9, wherein the telecommunications equipment includes one or more connection modules.

12. The telecommunications cabinet of claim 9, wherein the telecommunications equipment includes one or more connector storage modules.

13. A method of using a telecommunications cabinet comprising:
providing a telecommunications cabinet including in an interior with a front portion and a rear portion separated by a cable management panel;
providing telecommunications equipment connected to rear cabling in the rear space of the cabinet;
providing front cabling connected to the equipment and organized by the cable management panel;
removing an access panel for accessing the rear space from the front space to access rear cabling associated with a selected item of telecommunications equipment;
removing the selected item of telecommunications equipment from the cabinet while still being connected to the rear cabling.

14. The telecommunications cabinet of claim 10, wherein the telecommunications equipment includes one or more connection modules.

15. The telecommunications cabinet of claim 11, wherein the telecommunications equipment includes one or more connector storage modules.
